(19) United States
(12) Patent Application Publication
(10) Pub. No.: US 2025/0258059 A1
(43) Pub. Date: Aug. 14, 2025

(54) METHOD AND SYSTEM FOR DETECTING ONE OR MORE ANOMALIES IN A STRUCTURE

(71) Applicant: Commissariat à l’Energie Atomique et aux Energies Alternatives, Paris (FR)

(72) Inventor: Olivier MESNIL, Gif Sur Yvette Cedex (FR)

(73) Assignee: Commissariat à l’Energie Atomique et aux Energies Alternatives, Paris (FR)

(21) Appl. No.: 18/859,407

(22) PCT Filed: Apr. 27, 2023
(86) PCT No.: PCT/EP2023/061155

§ 371 Date: Oct. 23, 2024

(30) Foreign Application Priority Data
Apr. 28, 2022 (FR) FR2204010

(51) Int. Cl. G01M 7/02

(52) U.S. Cl. CPC G01M 7/025

(57) ABSTRACT

A method for detecting one or more anomalies in a structure, including a learning phase that includes obtaining healthy data respectively associated with N distinct sets of conditions of use of the structure; projecting the healthy data into a latent space with a dimension smaller than the dimension of the healthy data; and determining the outline of the set of healthy data projected into the latent space. Further, an operational phase includes obtaining, through a preliminary measurement, test data representative of the current state of the structure; projecting the test data into the latent space; and detecting of at least one current anomaly in the structure as soon as a test data element is outside the outline.

The present invention relates to a method for detecting one or more anomalies in a structure and for structural health monitoring (SHM) of said structure, wherein an anomaly corresponds to changes in the physical and/or geometrical properties of the structure, said structure carrying at least one sensor for measuring at least one characteristic of said structure, the method comprising at least one learning phase and at least one operational phase.

The invention further relates to a computer program including software instructions which, when executed by a computer, implement such a method for detecting one or more anomalies in a structure.

The invention further relates to an electronic device for detecting one or more anomalies in a structure, said structure carrying at least one sensor configured to generate and receive guided waves, the device comprising a learning unit and a test unit.

The invention further relates to a system for detecting one or more anomalies in a structure.

The present invention relates to the field of Structural Health Monitoring (SHM) aimed at detecting and characterizing damage (i.e. anomalies) in structures/infrastructures. Such structural anomalies correspond to modifications of the physical and/or geometrical properties of the structure considered apt to affecting the performance and/or reliability thereof.

Such a structural health monitoring is implemented using integrated sensors, e.g. piezoelectric sensors apt to emit and receive ultrasonic guided elastic waves.

The permanent integration of sensors on or within structures/infrastructures to monitor the condition thereof makes it possible, in particular, to guarantee the safety of supporting structures corresponding to thin and/or long mechanical components, such as wind turbine blades, fuselages or aircraft engine components, metal or composite pipes, power cables, bridge suspension cables, train rails, etc.

More particularly, guided elastic ultrasonic waves emitted by such sensors are used to detect structural defects leading to discontinuities or geometry variations, such as cracks, delamination in composite fuselages, corrosion leading in particular to loss of thickness in metals, etc., at an early stage and thereby monitor same over decades.

Such detection is generally well mastered in laboratories where external effects are limited, controlled and calibrated.

The main challenge associated with such a structural diagnosis is, in real conditions, related to the presence of epistemic uncertainties on the structure or instrumentation such as the positions of the sensors, the properties of the sensors, the elastic or geometrical properties of the structure, and to the presence of unsupervised (i.e. unknown) external influence effects evolving with distinct time dynamics.

It should be noted that “epistemic uncertainties” refers to uncertainties due to a lack of knowledge which can be reduced by trying to acquire more knowledge via e.g. data collection, expert assistance, accelerated tests, etc. It should be noted that in the SHM context, the reduction of such uncertainties is generally prohibitive in terms of cost, hence the use of the term uncertainties.

Such unsupervised external influence effects can be classified on the one hand as so-called “rapid” effects, exhibiting a variation on a time scale ranging from hour to day, such as the variation in temperature, humidity and stress (i.e. stresses exerted on a material), and on the other hand, so-called “slow” effects,” showing a variation on a time scale of the order of month, year, etc., such as the aging of sensors, the modification of material properties, structure or coupling between sensors and structure, and due to thermomechanical or other.

In practice, the signatures of the early defects are much smaller than the perturbations on the measurements associated with the presence of such epistemic uncertainties and/or the presence of such unsupervised influence effects. In other words, guided waves, in particular elastic and ultrasonic waves, apt to detect structural defects, via the signature thereof, are not only sensitive to defects, but also to external and operational effects such as temperature, humidity, uncertainties on sensors, aging, etc.

A conventional solution aims to compensate for epistemic uncertainties by means of a reference state, i.e. a measurement in the absence of a defect and then by comparing the current state with the reference state, in particular by subtraction, correlation, etc. while assuming that the only difference between reference and current states can only be attributed to the presence of a defect, but that all other operating parameters, except at best a single fast-acting parameter such as temperature, are equal between the two states-the reference state and the current state.

To compensate for rapid effects, such as a variation of temperature, signal processing is usually used.

Such a conventional solution is limiting, often prohibitive in terms of experimental design, and likely to lead to the detection of a false positive or a false negative. Indeed, such a solution of the prior art implies first of all a “perfect” instrumentation of the structure before the presence of a defect under identical conditions of use or at best to within a factor such as temperature.

Temperature compensation is also limited in terms of the maximum compensable range, which is currently on the order of a difference of maximum difference of 15°.

Moreover, effects other than temperature, such as external forces, are more difficult to reproduce in the laboratory, and the simultaneous presence of a plurality of effects has not really been explored so far, nor the evolution of the reference state over time, reference state that is liable to change despite the absence of a defect.

In other words, conventional solutions do not take into account the aforementioned slow effects, and are implemented on the assumption that the system behaves nominally over long periods of time, which is of course not satisfactory when referring to the instrumentation of a structure over several decades during which the aging of the measurement sensor and of the coupling thereof to the structure is inevitable and generates a slow deviation of the signals received by the measurement sensor, likely to be misinterpreted as a defect, or to hide a defect.

The goal of the present invention is thus to propose a method and a device apt to provide an early and reliable diagnosis of structural defects under real conditions of use in the presence of epistemic uncertainties and unsupervised external effects, both with a fast dynamics (i.e. on the order of an hour to several days) and with slow dynamics (i.e. on the order of a month to several years).

To this end, the subject matter of the invention is a method for detecting one or more anomalies in a structure and for structural health monitoring (SHM) of said structure, an anomaly corresponding to modifications of the physical and/or geometrical properties of the structure, said structure carrying at least one sensor configured to generate and receive guided waves, the method comprising at least one learning phase and at least one operational phase,
a learning phase comprising the following steps:
   obtaining a set of healthy data representative of N healthy states of said structure respectively associated with N sets, distinct in pairs, of conditions of use of said structure, N being an integer, two distinct sets having at least one condition of use distinct from one set to another,
said obtaining of a set of healthy data being implemented via a plurality of Q measurement sensors carried by said structure forming a network of sensors, Q being an integer greater than one, at least one of said Q sensors being configured to generate and receive guided ultrasonic elastic waves;
   projecting said set of healthy data onto a latent space of reduced dimension compared to the dimension of said set of healthy data;
   determining the outline of said set of healthy data projected onto said latent space;
the operational phase comprising the following steps:
   obtaining, by prior measurement via said at least one sensor, a set of test data representative of the current state of said structure;
   projecting said test data set onto said latent space;
   detecting at least one current anomaly of said structure as soon as an element of said test data set is outside said outline.

The aim of the present method is to quantify the extent to which signal data, corrupted on various time scales, can be used for the analysis of structural states. Such a method can thereby be used to compensate for the influence of the aforementioned supervised and/or unsupervised external effects without erasing the signature of the small defects that it is sought to detect.

More precisely, the invention consists in obtaining all the data of the signals which can be measured under healthy real conditions, said data being subsequently called healthy data, i.e. in the absence of any defect, with the goal of detecting a defect by the absence the defect from the set. In other words, obtaining said set means building a digital twin describing all the healthy signals to then detect an anomaly as beyond the outline of the “healthy” space described by the twin. Such a “healthy” space obtained according to the present invention is an important and differentiating element with respect to conventional solutions. Indeed, according to the present invention, it is not sought to model defects, since the defects will be detected by the absence thereof from the set of healthy data. Not modeling defects is a significant advantage because thereof means not making assumptions related to the typology, position or size of defects.

Since there are an infinite number of defect-free signals, the present invention further proposes to go through a reduction in dimensionality, via a latent space, to describe the characteristics of the signals in a healthy state.

According to other advantageous aspects of the invention, the method for detecting one or more anomalies in a structure comprises one or a plurality of the following features, taken individually or according to all technically possible combinations:
said set of healthy data is obtained following a prior calibration phase of said structure for the N sets, distinct in pairs, of conditions of use of said structure;
said set of healthy data is obtained following a prior simulation phase of said structure for the N sets, distinct in pairs, of conditions of use of said structure
said set of healthy data is obtained following a prior hybrid phase of calibration and/or simulation of said structure for the N sets, distinct in pairs, of conditions of use of said structure;
the method comprises, during said hybrid preliminary phase, a compensation step by transfer learning in the event of a deviation between calibration and simulation for the same set of conditions of use of said structure;
said latent space of reduced size is obtained by either supervised or unsupervised dimensional reduction;
said unsupervised dimensional reduction is implemented by means of one of the elements belonging to the group comprising at least:
   a principal components analysis,
   an autoencoder trained beforehand to compress and decompress the signals from the healthy data set, and of which only the part dedicated to compression is used to implement said dimensional reduction.
   a self-regressive process;
said supervised dimensional reduction is implemented by means of a neural network;
said neural network is a neural network the type of which belongs to the group comprising:
   a convolutional neural network;
   a network of recurrent neurons;
   a multilayer perceptron;
said determination of outline consists of:
   searching, in said latent space, for the spherical or elliptical envelope of minimum radius(es) encompassing the points of said set of healthy data projected onto said latent space, or
   searching in the latent space of the hyperplane furthest from the origin which separates, from the origin, the points of said set of healthy data projected onto said latent space, or
   using other types of anomaly detection such as robust estimation of the covariance matrix, known isolation forest, or else using outlier detection with a local outlier factor.

The invention further relates to a computer program including software instructions which, when executed by a computer, implement a method for detecting one or more anomalies in a structure as defined hereinabove.

A further subject matter of the invention is a system for detecting one or more anomalies in a structure and for structural health monitoring (SHM) of said structure, an anomaly corresponding to modifications of the physical and/or geometrical properties of the structure, said system comprising a plurality of Q sensors for measuring at least one characteristic of said structure, carried by said structure and forming an array of sensors, Q being an integer greater than one, at least one of said Q sensors being configured to generate and receive guided ultrasonic elastic waves, said system comprising a device in said structure and comprising a learning unit and a test unit,
the learning unit comprising:
   a first obtaining module configured to obtain, via said plurality of Q measurement sensors, a set of healthy data representative of N healthy states of said structure respectively associated with N sets, distinct in pairs, of conditions of use of said structure, N being an integer, two separate sets with at least one condition of use distinct from one set to another;
   a first projection module configured to project said set of healthy data into a latent space of reduced dimension compared to the dimension of said set of healthy data;
   a determination module configured to determine an outline of said set of healthy data projected onto said latent space;
the test unit comprising:
   a second obtaining module configured to obtain, by measurement via said at least one sensor, a set of test data representative of the current state of said structure;
   a second projection module configured to project said test data set onto said latent space provided by the projection module of said learning unit;
   a detection module configured to detect at least one current anomaly of said structure as soon as an element of said test data set is outside said outline provided by said determination module of said learning unit

Such features and advantages of the invention will become clearer upon reading the following description, given only as a non-limiting example, and made with reference to the enclosed drawings, wherein:

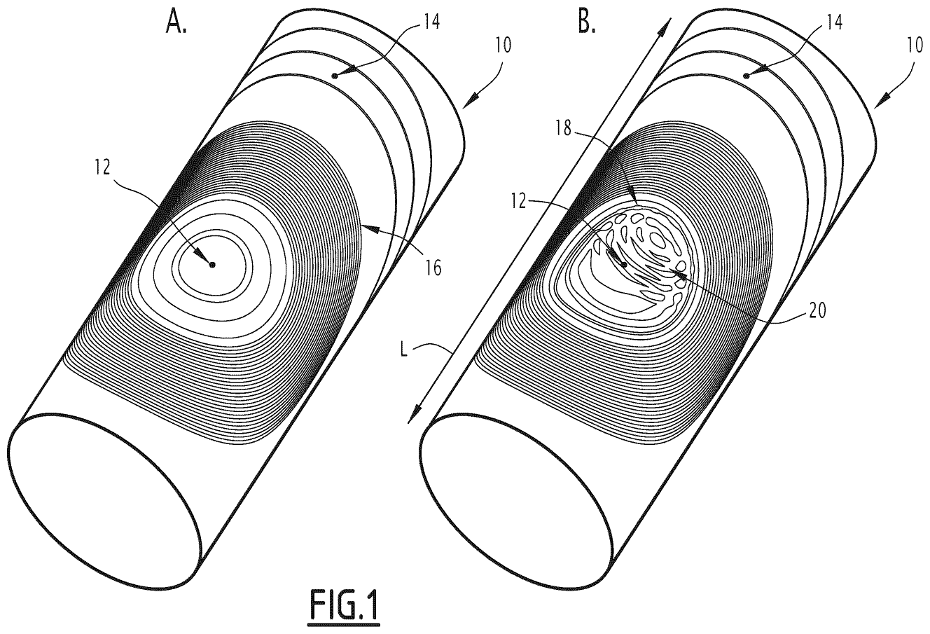

FIG. 1 illustrates the effect of a structural defect on the propagation of guided waves on the surface of a structure.

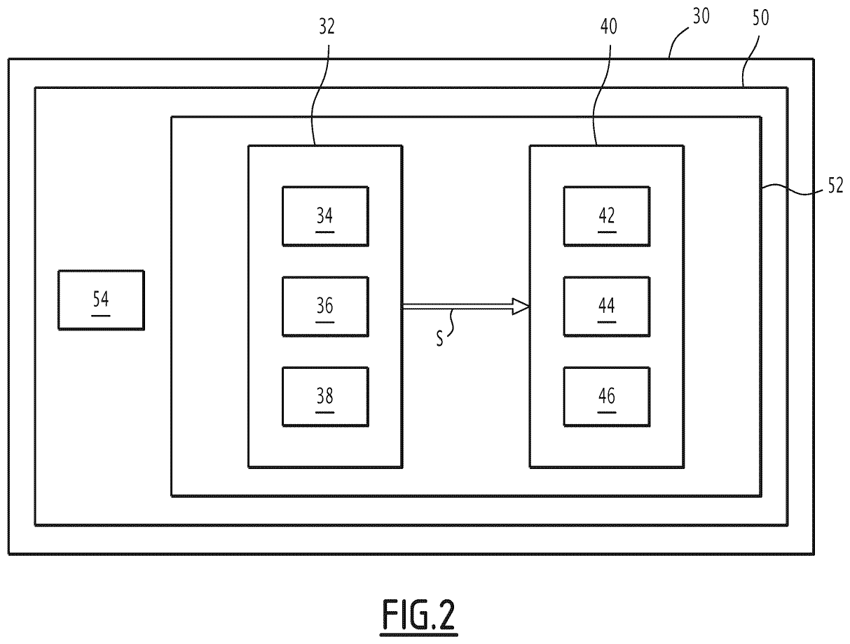

FIG. 2 is a schematic view of an electronic device for detecting one or more anomalies in a structure according to the invention;

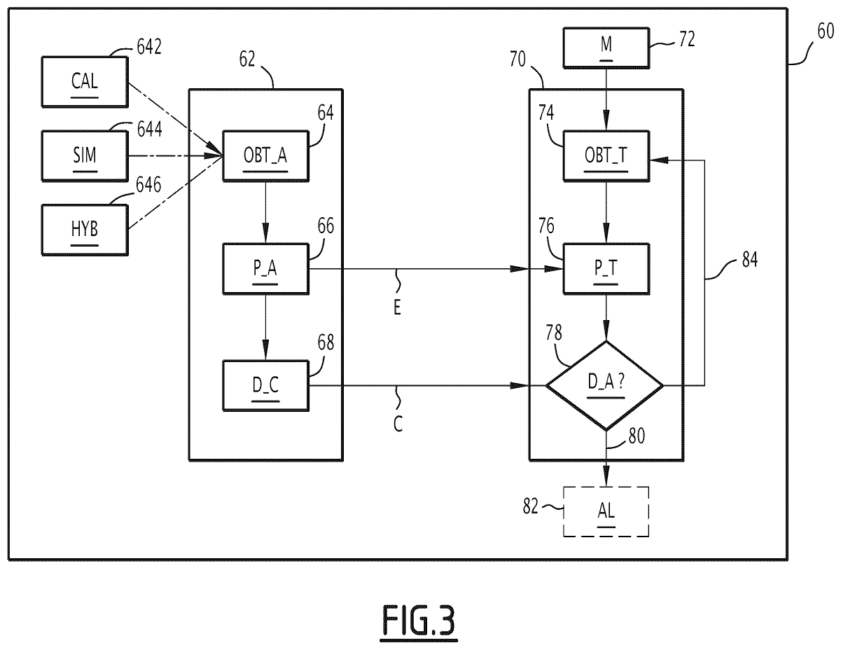

FIG. 3 is an organization chart of a method for detecting one or more anomalies in a structure according to the present invention;

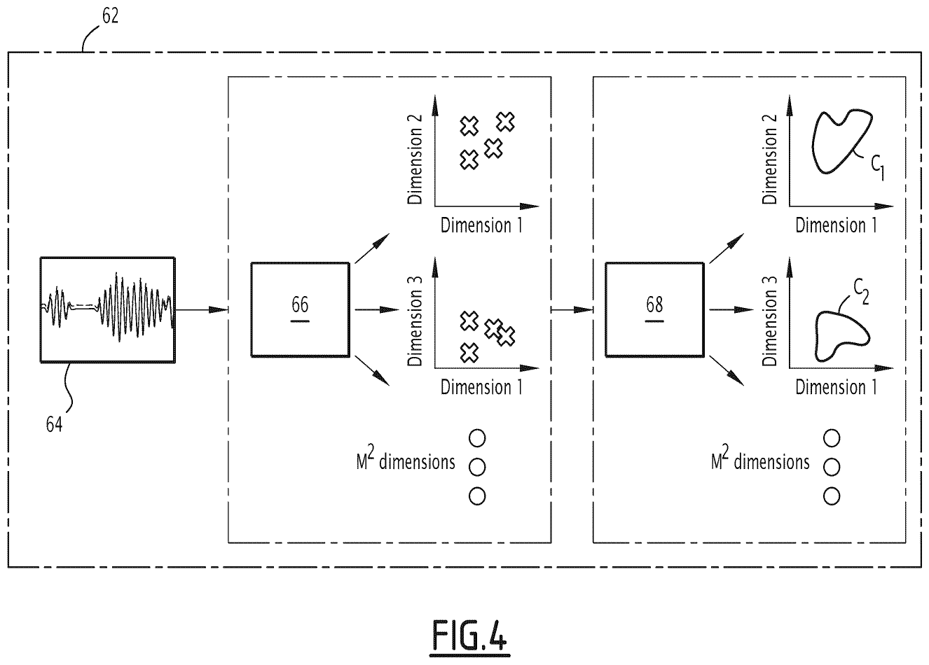

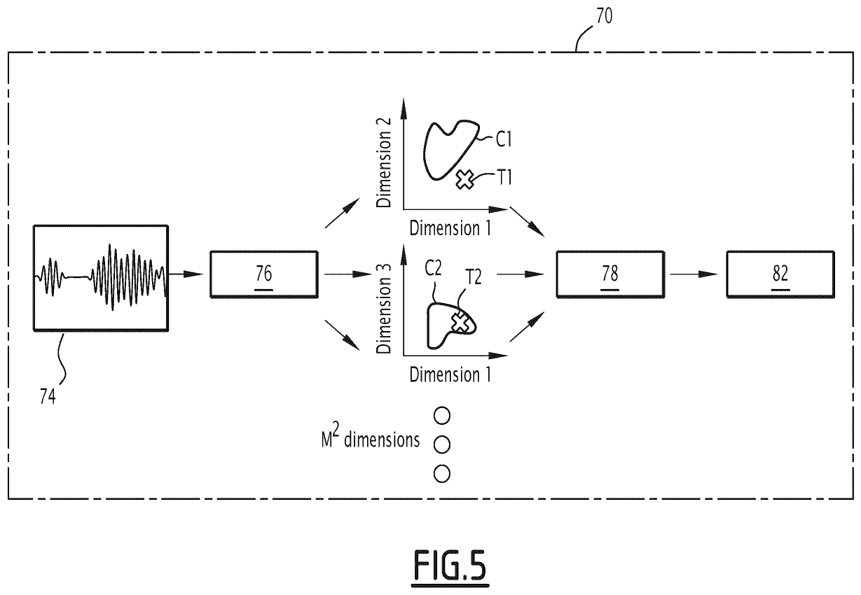

FIGS. 4 and 5 illustrate the learning phase and the operational phase, respectively, of the method according to the present invention.

In FIG. 1, an example of guided wave propagation on the surface of a structure 10 is illustrated for the defect-free structure in view A and in the presence of a defect in view B.

More precisely, on view A of the present example, the defect-free structure 10 corresponds to a defect-free cylindrical pipe of length L and carrying on the surface at least one measurement sensor in an uncontrolled environment, e.g. configured to generate, via the element 12 and receive, via the element 14, guided waves 16, in particular elastic and ultrasonic waves. For example, such a sensor belongs to the group comprising at least: piezoelectric sensors, an electro-magneto-acoustic transducer EMAT, a polyvinylidene fluoride PVDF sensor, etc. According to hybrid instrumentation, reception via the element 14 can also be ensured by one of the Bragg gratings on optical fiber.

Other types of sensors are suitable for use as soon as same are apt to take a measurement in an uncontrolled environment, e.g. sensors based on the use of ultrasound in general, including, as mentioned hereinabove, sensors apt to generate and receive guided waves, but also sensors for measuring eddy currents or vibrations, etc. In view B, the presence of a defect 18 on the surface of the pipe modifies the propagation of the guided waves by generating reflected guided waves 20.

FIG. 2 is a schematic view of an electronic device 30 for detecting one or more anomalies in a structure according to the present invention. Such a device 30 comprises an automatic learning unit 32 comprising a first obtaining module 34 configured to obtain a set of healthy data representative of N healthy states of said structure respectively associated with N sets, distinct in pairs, of conditions of use of said structure, N being an integer, two distinct sets having at least one distinct use condition from one set to another.

The learning unit 32 further comprises a first projection module 36 configured to project said set of healthy data (also called a healthy base comprising N samples, each sample being of dimension P) onto a latent space E of reduced dimension with respect to the dimension of said set of healthy data.

According to an optional aspect, such a latent space E is configured to describe the aforementioned perturbing effects as simply as possible, and is ideally linear, if not monotonic.

The learning unit 32 further comprises a determination module 38 configured to determine an outline C, in particular a multidimensional outline, of said set of healthy data projected onto said latent space.

Furthermore, the electronic device 30 comprises a test unit 40 apt to receive as input the output S of the learning unit 32 and comprising a second obtaining module 42 configured to obtain, by measurement via said at least one sensor, a set of test data representative of the current state of said structure 10.

The test unit 40 further comprises a second projection module 44 configured to project said set of test data onto said latent space provided by the first projection module 36 of said learning unit 32.

The test unit 40 further comprises a detection module 46 configured to detect at least one current anomaly of said structure as soon as an element of said set of test data is outside said outline provided by said module 38 for determining said learning unit 32.

In other words, the learning unit 32 is suitable for building by training a digital twin describing all the healthy data to detect an anomaly as beyond the healthy space described by the digital twin.

In the example shown in FIG. 2, the electronic device 30 for detecting an anomaly or more anomalies comprises an information processing unit 50 consisting e.g. of a memory 52 and of a processor 54 associated with the memory 52.

In the example shown in FIG. 2, the first obtaining module 34, the first projection module 36, the determination module 38, the second obtaining module 42, the second projection module 44 and the detection module 46 are each implemented in the form of software or a software brick, executable by the processor 54. The memory 52 of the electronic device 30 for detecting one or more anomalies in a structure is then apt to store, in order to implement a learning phase, a first production software, a first projection software and a determination software, and to implement a test phase, a second production software, a second projection software, and a detection software. The processor 54 is then apt to execute each of the software from the first obtaining software, the first projection software, the determination software for a learning phase, and for a test phase, a second obtaining software, a second projection software and a detection software.

In a variant (not shown), the first obtaining module 34, the first projection module 36, the determination module 38, the second obtaining module 42, the second projection module 44 and the detection module 46 are each produced in the form of a programmable logic component, such as an FPGA (Field Programmable Gate Array), or a GPU (Graphics Processing Unit) or else in the form of an integrated circuit, such as an ASIC (Application Specific Integrated Circuit).

When the electronic device 30 for detecting an anomaly or more anomalies is produced in the form of one or a plurality of software programs, i.e. in the form of a computer program, same is further apt for being recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM memory, a RAM memory, any type of non-volatile memory (e.g. EPROM, EEPROM, FLASH, NVRAM), a magnetic card or an optical card. A computer program containing software instructions is then stored on the readable medium.

In a manner not shown, the invention further relates to a system for detecting one or more anomalies in a structure, said system comprising such an electronic device 30 for detecting one or more anomalies in a structure, illustrated by FIG. 2, and further comprising a plurality of Q sensors carried by said structure, configured to generate and receive guided waves and forming an array of sensors, Q being an integer greater than one. According to a particular aspect, at least one of said Q sensors is configured to generate and receive guided ultrasound elastic guided waves.

The information is thus, in such case, processed at the sensor network by using Q²−Q signals corresponding to the paths between the Q sensors, or Q² signals if the signals emitted and received by the same sensor are used. The network of sensors Q is, where appropriate, supplemented by an acquisition chain (not shown) configured to process the measurements captured via said network of Q sensors.

Indeed, it is not excluded that a signal acquired by a sensor element 14 as illustrated in FIG. 1, in the presence of a defect under conditions of use U₁, is identical to a signal acquired in the absence of a defect under conditions U₂. To remove such ambiguity, the present invention then proposes to rely on the data coming from a network of sensors. Indeed, because of the asymmetry of the defects, the contribution of a given defect varies according to the paths traveled by the waves, which is not the case for the operational conditions. The data are thus processed at the sensor network Q²−Q signals corresponding to the paths between the Q sensors.

The operation of the electronic device 30 for detecting one or more anomalies in a structure will now be described with reference to FIG. 3 which schematically illustrates an example of implementation, according to the present invention, of a method 60 for detecting one or more anomalies in a structure, such as e.g. the structure 10 shown in FIG. 1.

The method 60 according to the present invention comprises first of all an automatic learning phase 62, also illustrated in greater detail in FIG. 4 described thereafter.

According to a first step 64 of the learning phase 62, the electronic device 30 for detecting one or more anomalies, via the first obtaining module 34 thereof, obtains OBT_A, a set of healthy data representative of N healthy states of said structure respectively associated with N sets, distinct in pairs, of conditions of use of the structure, where N is an integer, two distinct sets having at least one condition of use distinct from one set to another.

The N sets, distinct in pairs, of conditions of use of the structure, aim in particular to cover the main operating parameters likely to influence the measurements, namely same associated with the aforementioned epistemic effects, such as the placement of sensors, the properties and geometry of the structure, the properties of the sensors, same associated with the aforementioned rapid effects, such as temperature, humidity, pressure, forces applied to the structure under consideration, same associated with slow effects such as aging of the sensor(s), of the structure and of the coupling between the structure and the sensor(s).

As illustrated by FIG. 2, such an obtaining 64 follows one of the three optional preliminary phases 642, 644, 646, implemented by said electronic device 30 for detecting one or more anomalies or by a separate device, the first optional preliminary phase 642 corresponding to a preliminary phase of calibration CAL of said structure for the N sets, distinct in pairs, of conditions of use of said structure.

In other words, according to the first option, the healthy data set is determined beforehand by experience during a calibration phase 642, often likely to be prohibitive in terms of cost/duration and consisting in instrumenting healthy structures and acquiring data over long periods. Such a calibration phase 642 involves both the supervision of the measured data to ensure that there are no defects, and the completeness to ensure that a statistically sufficient number of combinations of parameters are explored. Depending on the application, such a calibration is available and carried out beforehand, e.g. during a research and development phase of the structure in question, the obtaining step 64 then consisting in recovering the set of healthy data coming from the CAL calibration phase 642.

According to a second preferential option, said set of healthy data is obtained at the end of a prior SIM simulation phase 644 of said structure for the N sets, distinct in pairs, of conditions of use of said structure, the obtaining step 64 then consisting in recovering the set of healthy data resulting from the SIM simulation phase 644.

The second option is a privileged approach, according to the present invention, the prior simulation 644 serving to establish, quickly and at a lower cost than the first experimental option, models (i.e. simulations) of the signals subjected to the disturbing parameters corresponding to the epistemic uncertainties and to the aforementioned unsupervised external effects, and so generate healthy data on the fly.

Indeed, depending on the application, it may prove prohibitive according to the first [option] to acquire all the healthy signals possible in experiment, more particular because the effects of aging are only visible after several years and because it would be necessary to instrument a lot of structures to see all the variabilities of structures/instrumentation.

Such a second option using simulation implies, moreover, having available models of all the phenomena influencing the guided waves, such models being suitable to be trained/calibrated/tested/validated on samples representative of the structure and of the application in question, significantly limiting the cost with respect to the experimental solution associated with the aforementioned first option. Advantageously, models (i.e. simulations) of defects are not necessary, since the present invention proposes to focus on healthy data

According to a third option, said set of healthy data is obtained following a prior hybrid phase 646 of calibration and/or simulation of said structure for the N sets, distinct in pairs, of conditions of use of said structure, the obtaining step 64 then consisting in recovering the set of healthy data from the hybrid phase 646 HYB.

According to a particular optional aspect of the third option, said hybrid preliminary phase comprises a step, not shown, of compensation by transfer learning in the event of a difference between calibration and simulation for the same set of conditions of use of said structure. In other words, such an optional aspect is implemented in particular in the case where the models (i.e. simulations) are not perfect, i.e. without rigorous superposition between simulated and experimental signals with identical parameters, and proposes to compensate the deviation by transfer learning, an example of which is described in patent application FR 3,113,530, such a transfer learning making possible, in a hybrid way, to recalibrate models using an affordable number of experiments.

Independently of the option implemented prior to the obtaining step 64, as indicated hereinabove, it should be noted that for each option, a system for detecting one or more anomalies in a structure is considered, said system comprising the electronic device 30 for detecting one or more anomalies in a structure, illustrated by FIG. 2, and further comprising a plurality of Q sensors carried by said structure, configured to generate and receive guided waves and forming an array of sensors, Q being an integer greater than one, and N being such that N=Q²−Q. The network of Q sensors serves to make sure that the set of data recovered during the obtaining step 64 is healthy.

Indeed, the external effects are relatively homogeneous and perceived by all the sensors. Such is the case e.g. of the temperature which can affect all the measuring sensors in a relatively homogeneous manner. On the other hand, a defect will only influence certain sensors and in a quite different way, due to the limited size thereof and to the natural asymmetry thereof.

In addition, regardless of the option implemented prior to the obtaining step 64, the learning phase 62 of the method 60 according to the present invention further comprises a step 66 of projection P-A of said set of healthy data onto a latent space E of reduced dimension with respect to the dimension of said set of healthy data. Indeed, the set of healthy data has generally a large dimension, in particular on the order of 10³ to 10⁵ which is suitable for slowing down the detection of an anomaly during the operational test phase.

The projection step 66 thus aims to reduce the dimensions of the healthy learning data, by describing (i.e. projecting) same onto a latent space of reduced dimension, e.g. on the order of 10 to 10² for original dimensions of 10³ to 10⁵, respectively.

The reduced latent space is obtained by supervised or unsupervised dimensional reduction

It should be noted that since the healthy data do not contain any defects, an unsupervised dimensional reduction 66 makes it possible not to have any a priori, unfavorable to the detection of defects. In other words, an unsupervised dimensional reduction 66 is suitable to be implemented to prevent creating a bias going against the signature of the defects, absent from the initial set of healthy data.

According to a first option, when dimensional reduction 66 is unsupervised, same is implemented by means of one of the elements belonging to the group comprising at least:
a PCA (Principal Component Analysis),
an autoencoder trained beforehand to compress and decompress the signals from the healthy data set, and of which only the part dedicated to compression is used to implement said dimensional reduction.
a self-regressive process

In other words, the first projection module 36 is apt to implement a principal components analysis, making sure in particular that the loss of variance is less than the influence of a defect sought subsequently during the operational phase. In the case of the implementation of an autoencoder, the first projection module 36 is configured to train the first half of said autoencoder to compress/decompress the signals, and the dimensional reduction is obtained by retaining only the central component of the autoencoder, commonly called “embedding”.

According to a second option, when the dimensional reduction 66 is supervised, in particular to best adapt a set of healthy data resulting from a prior simulation, the physics of which is well mastered, and to favor the detection of defects, such supervised dimensional reduction 66 is implemented by means of a neural network, the type of which belongs e.g. to the group comprising:
a convolutional neural network;
a network of recurrent neurons;
a multilayer perceptron.

Such a neural network is suitable in particular for modeling perturbing data and effects such as temperature, humidity, etc., the latent space of reduced dimension then corresponding to all the outputs of the neural network.

Moreover, as illustrated by FIG. 2, the learning phase 62 of the method 60 according to the present invention further comprises a step 68 of determining the outline C, implemented automatically via said determination module 38 or manually, of said set of healthy data projected into said latent space E. In other words, during said step 68, it is sought, by training, to describe the outlines of the set of healthy data, in order detect subsequently, during an operational phase, an anomaly outside said outline.

To this end, as described in particular by V. Chandola et al. in the publication “Anomaly detection: A survey”, ACM Computing Surveys Volume 41 Issue 3 Jul. 2009 Article No.: 15 pp 1-58, said determination 68 of outline is e.g. suitable for comprising:
the search, in said latent space E, for the envelope, in particular spherical or elliptical, of minimum radius(s) encompassing the points of said set of healthy data projected onto said latent space, according to the technique known as “support vector data description”, or
the search in the latent space E of the hyperplane furthest from the origin which separates, from the origin, the points of said set of healthy data projected onto said latent space, according to the technique known by the English name of “one class support vector machine”, or
using other types of detection of an anomaly, such as robust covariance, isolation forest, or else with a detection of outliers with the local outlier factor LOF.

Once the learning phase 62 has been carried out, the outputs S, comprising the latent space E and the outline C, of the learning unit 32 are transmitted to the test unit 40 suitable for implementing an operational phase 70, reiterated after each step 72 of measurement M of a current state of the structure considered. As indicated hereinabove, each measurement 72 is obtained in particular by means of a plurality of Q sensors carried by said structure, configured to generate and receive guided waves and forming a network of sensors, Q being an integer greater than one, and N being such that N=Q²−Q.

It should be noted that the learning phase 62 is suitable for being reiterated in particular to take into account additional parameters suitable for influencing the propagation of the guided waves depending upon the application of the desired structure, e.g. in the event of a change in the climate zone of operation of said structure.

Moreover, according to an aspect not shown, the present invention makes it possible to take into account the knowledge of a physical parameter of the condition of use at the time of the measurement 72, such a physical parameter corresponding in particular to the temperature, to reduce the healthy data set coming from the learning 62 to a healthy data set reduced by one dimension due to the known physical parameter.

In other words, in such case, the learning 62 is reiterated to obtain said reduced set of healthy data, and the outline C′ thereof in a latent space E′ associated with the reduction in dimension linked to the perfect knowledge of a parameter of use such as the temperature during the measurement 72. Such an outline C′ is necessarily smaller than the outline C associated with the set of healthy data obtained for a plurality of distinct operating temperatures of the structure. Such a smaller outline C′ makes the approach more reliable, and in the extreme case where all influential parameters are known, which does not seem possible in practice, due to epistemic uncertainties, the set of healthy data would then contain a single dataset.

Such an operational phase 70, also illustrated and described hereinafter in relation to FIG. 5, comprises a first step 74 of obtaining OBT_T, via the second obtaining module 42 shown in FIG. 2, a set of test data representative of the current state of said structure considered, wherein the presence of a defect is unknown.

During a step 76 implemented by the second projection module 44 shown in FIG. 2, the set of test data representative of the current state of said structure considered is then projected, via a projection P_T, onto the latent space E, used during the learning phase 62.

During a step 78, implemented automatically by the detection module 46 of FIG. 2 or manually, at least one current anomaly of said structure is then detected as soon as an element of said test data set is outside said outline C.

In a manner not shown, the method 60 is also suitable for comprising an evaluation of the biases and the errors due to modeling and to automatic learning in order to provide a measure of confidence in the defect diagnosis (i.e. the detection of anomalies) proposed according to the present invention.

FIG. 4 diagrammatically illustrates in greater detail the learning phase 62 previously described, with the step 64 of obtaining a set of healthy data representative of N healthy states of said structure respectively associated with N sets, distinct in pairs, of conditions of use of said structure, N being an integer, two distinct sets having at least one distinct use condition from one set to another.

More precisely, as illustrated in FIG. 4, during the obtaining step 64, the healthy data associated with as many N signals as distinct sets of conditions of use of a healthy structure without defects, are obtained. In other words, each of the N signals represented is obtained with a variation of at least one operating parameter such as the position of at least one sensor, the temperature and/or the aging of said at least one sensor.

The step 66 of projecting said set of healthy data onto a latent space of reduced dimension M with respect to dimension N of said set of healthy data is illustrated in FIG. 4 by M² two-dimensional representations of healthy data represented by crosses.

It should be noted that such two-dimensional representations are used herein only for the purpose of illustrating and explaining the multidimensional aspect of the latent space, the multidimensional representation of which is complex.

The step 68 of determining the outline of said set of healthy data (also called healthy base comprising N samples, each sample being of dimension P) projected onto said latent space, is illustrated in FIG. 4 by the outlines C₁ and C₂, the outline C₁ surrounding the healthy data crosses projected during step 66 onto a two-dimensional part with dimension 1 on the abscissa and dimension 2 on the ordinate of the latent space of M dimensions (i.e. size M<P necessarily due to the reduction of dimension), the outline C₂ surrounding the healthy data crosses projected during step 66 onto a two-dimensional part with the dimension 1 on the abscissa and the dimension 3 on the ordinate of the latent space with M dimensions.

FIG. 5 diagrammatically illustrates in greater detail the operational phase previously described, with the step 74 of obtaining, by prior measurement via said at least one sensor, a set of test data representative of the current state of said structure.

The step 76 of projecting said set of test data into said latent space, resulting from the learning 62 illustrated by FIG. 4, is represented in FIG. 5 by M₂ two-dimensional representations of the test data T₁ and T₂ represented by a cross in each two-dimensional representation.

The anomaly detection step 78 checks, in each two-dimensional representation, that the test data cross is in the associated healthy data outline, otherwise an anomaly 82 is detected as soon as a cross is outside a two-dimensional outline, which is the case for the cross T₁ which is outside the outline C₁ in the two-dimensional space of the dimensions 1 and 2, whereas when the dimensions 1 and 3 are considered, the cross T₂ is in the outline C₂. In other words, as soon as a position of test data outside the multidimensional outline is detected, in particular herein for the purpose of explaining and simplifying the representation within the M₂ two-dimensional representations, an anomaly is detected, and, where appropriate, in a manner not shown, an alert (not shown) is raised and/or a request for maintenance of said structure.

In other words, such a detection 78 is certainly rough but effective, and consists in considering that if the representation in the latent space of the set of test data is too far from the outline C of the set of healthy data, a defect is present.

According to a particular aspect, very dependent on the case of use considered, the distance from the test data representative of an anomaly (herein the cross T₁) to the outline, herein C₁, could be suitable for expressing the criticality of the detected defect.

A person skilled in the art would understand that the invention is not limited to the embodiments described, nor to the particular examples of the description, the above-mentioned embodiments and variants being suitable for being combined with one another so as to generate new embodiments of the invention.

Thereby, the present invention proposes a method and a device for detecting one or more anomalies in a structure which serve to build, by training, a digital twin describing the set of healthy data associated with a healthy state of the considered structure to then detect an anomaly as beyond the healthy space described by the digital twin.

In other words, the present invention serves to dispense with the creation of defects either experimentally or by simulation, going through learning by modeling only the healthy states.

According to one aspect of the invention implementing the obtaining of healthy data at least in part by simulation beforehand, it is possible to dispense with a prior calibration phase on real structures and under real conditions of use, or to significantly limit same in the case of hybrid preprocessing involving, at least in part, simulation.

Moreover, the present invention is generic with respect to influential parameters, because once the set of healthy data is obtained by learning, it is possible to rapidly develop same to take into account additional conditions of use of the structure and recalculate the multidimensional outline in latent space.

Thereby, the detection of an anomaly, as obtained via the present invention has intrinsic robustness with respect to the external parameters by integrating same from the outset into the learning of healthy data, so that the diagnosis (i.e. the detection) does not have an a priori on external conditions at the time of the application thereof with regard to the measurement of a current state of the structure.

Such a detection of an anomaly can reduce the environmental footprint of instrumented structures through preventive maintenance and the lengthening of the service life by detecting anomalies (i.e. defects) at an early stage.

1. A method for detecting one or more anomalies in a structure and structural health monitoring of said structure, an anomaly corresponding to changes in the physical and/or geometrical properties of the structure, said structure carrying at least one sensor for measuring at least one characteristic of said structure, the method comprising:
a learning phase, and
an operational phase, wherein the learning phase comprises:
obtaining a set of healthy data representative of N healthy states of said structure respectively associated with N sets, distinct in pairs, of conditions of use of said structure, N being an integer, two distinct sets having at least one condition of use distinct from one set to another, said obtaining of a set of healthy data being implemented via a plurality of Q measurement sensors carried by said structure forming a network of sensors, Q being an integer greater than one, at least one of said Q sensors being configured to generate and receive guided ultrasonic elastic waves;
projecting said set of healthy data onto a latent space of reduced dimension compared to the dimension of said set of healthy data;
determining the outline of said set of healthy data projected onto said latent space; and
the operational phase comprising:
obtaining, by prior measurement via said at least one sensor, a set of test data representative of the current state of said structure;
projecting said test data set onto said latent space; and
detecting at least one current anomaly of said structure as soon as an element of said test data set is outside said outline.

2. The method according to claim 1, wherein said set of healthy data is obtained following a prior calibration phase of said structure for the N sets, distinct in pairs, of conditions of use of said structure.

3. The method according to claim 1, wherein said set of healthy data is obtained following a prior simulation phase of said structure for the N sets, distinct in pairs, of conditions of use of said structure.

4. The method according to claim 1, wherein said set of healthy data is obtained following a prior hybrid phase ) of calibration and/or simulation of said structure for the N sets, distinct in pairs, of conditions of use of said structure.

5. The method according to claim 4, further comprising, during said hybrid preliminary phase, a compensation step by transfer learning in the event of a deviation between calibration and simulation for the same set of conditions of use of said structure.

6. The method according to claim 1, wherein said latent space of reduced dimension is obtained by supervised or unsupervised dimensional reduction.

7. The method according to claim 6, wherein said unsupervised dimensional reduction is implemented by means of one of the elements belonging to the group comprising at least:
a principal components analysis,
an autoencoder trained beforehand to compress and decompress the signals from the healthy data set, and of which only the part dedicated to compression is used to implement said dimensional reduction, and
a self-regressive process.

8. The method according to claim 6, wherein said supervised dimensional reduction is implemented by means of a neural network.

9. The method according to claim 8, wherein said neural network is a neural network the type of which belongs to the group comprising:
a convolutional neural network;
a network of recurrent neurons; and
a multilayer perceptron.

10. The method according to claim 1, wherein said determination of the outline comprises:
searching, in said latent space, for the spherical or elliptical envelope of minimum radius(es) encompassing the points of said set of healthy data projected onto said latent space,
searching in the latent space of the hyperplane furthest from the origin which separates, from the origin, the points of said set of healthy data projected onto said latent space, or
using other types of anomaly detection such as robust estimation of the covariance matrix, known isolation forest, or else using outlier detection with a local outlier factor.

11. A non-transitory computer-readable storage medium storing a computer program comprising software instructions which, when executed by a computer, implement, at least in part, the method for detecting one or more anomalies in the structure according to claim 1.

12. A system for detecting one or more anomalies in a structure and for structural health monitoring of said structure, an anomaly corresponding to modifications of the physical and/or geometrical properties of the structure, said system comprising a plurality of Q sensors for measuring at least one characteristic of said structure, carried by said structure and forming an array of sensors, Q being an integer greater than one, at least one of said Q sensors being configured to generate and receive guided ultrasonic elastic waves, said system comprising a device in said structure and comprising a learning unit and a test unit,
the learning unit comprising:
a first obtaining module configured to obtain, via said plurality of Q measurement sensors, a set of healthy data representative of N healthy states of said structure respectively associated with N sets, distinct in pairs, of conditions of use of said structure, N being an integer, two separate sets with at least one condition of use distinct from one set to another;
a first projection module configured to project said set of healthy data into a latent space of reduced dimension compared to the dimension of said set of healthy data, and
a determination module configured to determine an outline of said set of healthy data projected onto said latent space; and
the test unit comprising:
a second obtaining module configured to obtain, by measurement via said at least one sensor, a set of test data representative of the current state of said structure;
a second projection module configured to project said test data set onto said latent space provided by the projection module of said learning unit; and
a detection module configured to detect at least one current anomaly of said structure as soon as an element of said test data set is outside said outline provided by said determination module of said learning unit.
